(19) United States
(12) Patent Application Publication
(10) Pub. No.: US 2008/0062996 A1
(43) Pub. Date: Mar. 13, 2008

(54) Consumer Edge Initiated Pseudo-Wire Multi-Homing in Access Networks

(75) Inventors: John Kaippallimalil, Richardson, TX (US); Young Lee, Plano, TX (US); Linda Dunbar, Plano, TX (US)

Correspondence Address: CONLEY ROSE, P.C., 5601 GRANITE PARKWAY, SUITE 750, PLANO, TX, 75024, US

(73) Assignee: Futurewei Technologies, Inc., Plano, TX (US)

(21) Appl. No.: 11/531,551

(22) Filed: Sep. 13, 2006

(51) Int. Cl. H04L 12/56

(52) U.S. Cl. 370/395.1

(57) ABSTRACT

A telecommunications network component comprising a processor configured to implement a method comprising: receiving a data stream, establishing a virtual connection with a destination through one of a plurality of networks, and configuring the data packets for transportation to the destination over the virtual connection, wherein the data packets follow the virtual connection through the carrier network so long as a rerouting condition is not detected. Also disclosed is a method of routing order sensitive data, comprising: providing a connection to a plurality of carrier networks, establishing a plurality of pseudo-wires through the carrier networks, transmitting an order specific data over one of the pseudo-wires, and multi-homing to detect a rerouting condition on one of the pseudo-wires.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The present invention relates generally to telecommunications and data networks and specifically to an improved network that routes order sensitive data packets through multiple carrier networks.

Modem telecommunication and data networks are comprised of a plurality of individual networks that allow data to be transferred between various user devices. For example, data packets may travel from a user device, such as a cellular telephone or a computer, over a carrier network, and to another user device. These various networks and user devices can use the Transmission Control Protocol (TCP) to exchange data with one another. Specifically, the TCP is used to divide a data stream into a plurality of data packets, and to sequence the data packets so that they may be later reassembled. After the data packets are sequenced, the TCP passes the data packets to the Internet Protocol (IP) for delivery through the network. After the data packets pass through the network, the TCP verifies that all of the packets have been received and reassembles the packets in the correct order.

One of the problems with existing networks is that they do not control the order in which data packets are routed through the network. Various applications, such as Voice Over Internet Protocol (VOIP) require the data packets be received in substantially the same order that they were originated. TCP/IP does not maintain the order of the data packets because each individual packet is routed based on various routing criteria, such as the packet size and the available bandwidth of each link between the source and the destination. Even when all of the packets follow the same route, failures along the route can cause the packets to be delayed. Such a delay decreases the quality of service below an acceptable level for many applications. Therefore, a need exists for an improved network that is able to maintain the order in which data packets are transported over a network and adapt to changes and failures within the network.

### SUMMARY

In one aspect, the invention includes a telecommunications network component comprising a processor configured to implement a method comprising: receiving a data stream, establishing a virtual connection with a destination through one of a plurality of networks, and configuring the data packets for transportation to the destination over the virtual connection, wherein the data packets follow the virtual connection through the carrier network so long as a rerouting condition is not detected.

In another aspect, the invention includes a method of routing order sensitive data, comprising: providing a connection to a plurality of carrier networks, establishing a plurality of pseudo-wires through the carrier networks, transmitting an order specific data over one of the pseudo-wires, and multi-homing to detect a rerouting condition on one of the pseudo-wires.

Finally, the invention includes a system for transporting and receiving order specific data, comprising: a pseudo-wire device operable for communication with a plurality of carrier networks, the pseudo-wire device configured to establish a plurality of pseudo-wires through the carrier networks and route a plurality of data streams through the pseudo-wires, and a policy-based routing table accessible by the pseudo-wire device, wherein the pseudo-wire device uses the routing table to determine the pseudo-wires on which to route the data streams.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is one embodiment of a communications network.

FIG. 2 is a flowchart of one embodiment of the data transmission method.

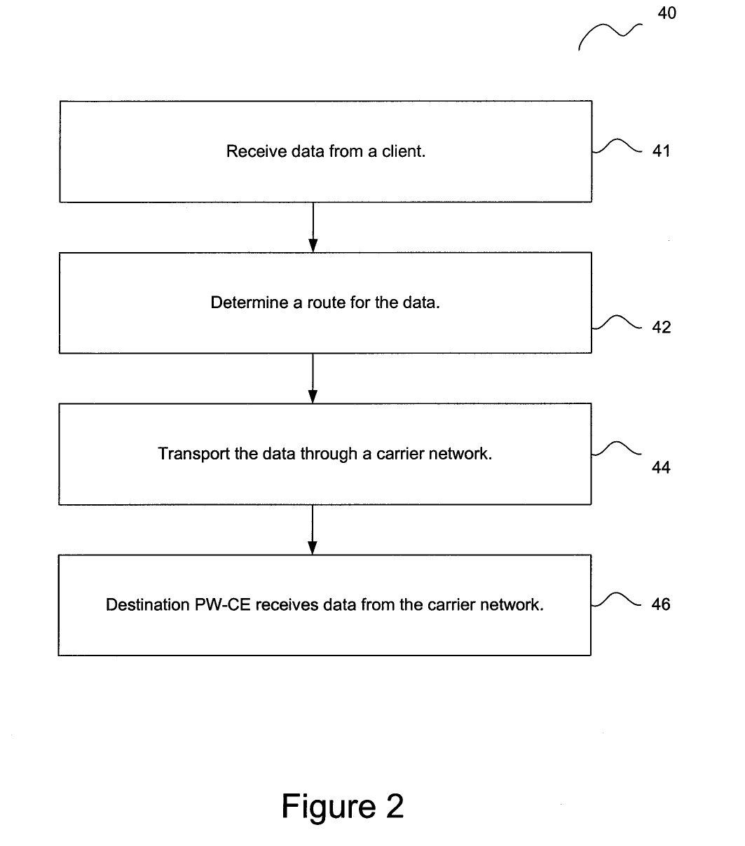

FIG. 3 is a flowchart or another embodiment of the data transmission method.

FIG. 4 is one embodiment of a general purpose computer system.

### DETAILED DESCRIPTION

It should be understood at the outset that although an illustrative implementation of one embodiment of the present disclosure is described below, the present system may be implemented using any number of techniques, whether currently known or in existence. The present disclosure should in no way be limited to the illustrative implementations, drawings, and techniques described below, including the exemplary design and implementation illustrated and described herein, but may be modified within the scope of the appended claims along with their full scope of equivalents.

Described herein is a network configuration that implements a plurality of pseudo-wires over a plurality of carrier networks. The pseudo-wires allow the order of data packets to be maintained from the source to the destination without the use of a transport protocol, such as TCP. In addition, the pseudo-wires are initiated at the customer edge, rather than the provider edge, so that a failure affecting a pseudo-wire in one carrier network does not adversely affect the pseudo-wires in other carrier networks. Further, the network configuration described herein allows the reliability of the data packets transported over the pseudo-wires to be classified and routed based on various properties, such as the Class of Service (CoS). These and other advantages are discussed in detail below.

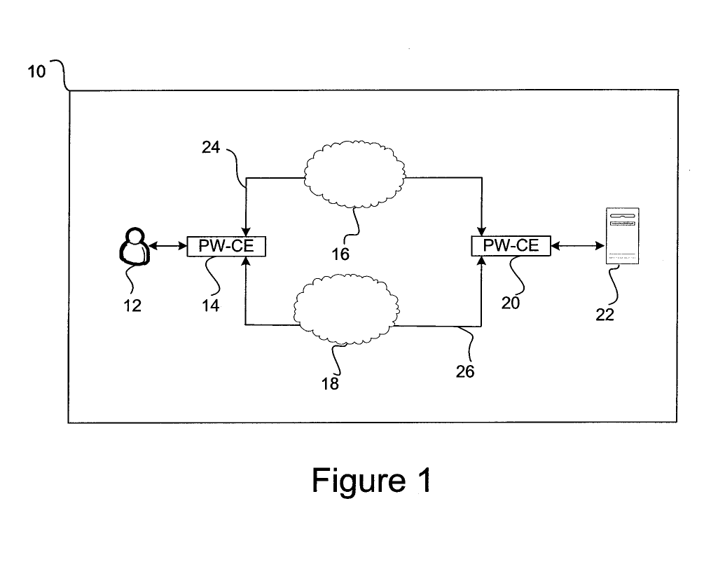

FIG. 1 illustrates a network 10 for transporting data packets from a source to a destination. The network 10 comprises a client 12, a central office 22, two carrier networks 16 and 18, two pseudo-wires 24 and 26, and two pseudo-wire customer edges (PW-CEs) 14 and 20. In various embodiments, the client 12 may be the source and the central office 22 may be the destination, or the central office 22 may be the source and the client 12 may be the destination. When the client 12 is the source and the central office 22 is the destination, data packets, such as IP data packets, originate at the client 12 and are forwarded to the PW-CE 14. The PW-CE 14 may then transport the data packets to the PW-CE 20 through carrier network 16 via pseudo-wire 24. Alternatively, the PW-CE 14 may transport the data packets to the PW-CE 20 through carrier network 18 via pseudo-wire 26. Upon receipt of the data packets, the PW-CE 20 transfers the data packets to the central office 22. Regardless of whether the source PW-CE 14 sends the data packets through carrier network 16 or through carrier network 18, the data packets arrive at the central office 22 in the same order that they were sent by the client 12. Unlike other pseudo-wire systems that are located within the carrier network or at the provider edge, the PW-CEs 14 and 20 described herein are located on the customer edge. Locating the PW-CEs 14 and 20 at the customer edge allows the PW-CEs 14 and 20 to be connected to a plurality of distinct carrier networks 16 and 18. Thus, if there is a problem with one carrier network such as the loss of an edge router in carrier network 16, the PW-CEs 14 and 20 can still establish a pseudo-wire 26 through another carrier network 18.

In an embodiment, the client is any device or network that may produce and/or receive data packets. The client may be a customer-oriented wire-line network or node, such as a Digital Subscriber Line (DSL) connection, or a customer-oriented wireless network, such as a cellular or one of the IEEE 802 networks. Alternatively, the client may be a fixed or mobile user-oriented device, such as a desktop computer, a notebook computer, a Personal Digital Assistant (PDA), or a cellular telephone. Because the client may produce and/or receive data packets, the client may be either a source or a destination as those terms are used herein.

In an embodiment, the carrier networks are any networks that are used to transport data between the client and the central office. In an embodiment, the carrier networks may be Packet Switched Networks (PSNs) that transport IP traffic between the central office and a plurality of remote clients. For example, the carrier networks may transfer data packets between several DSL Access Multiplexers (DSLAMs) and/or Radio Network Controllers (RNCs) and an Internet Protocol/Multi-protocol Packet Label Switching (IP/MPLS) network. Alternatively, the carrier networks may be any other type of data transport network known to persons of ordinary skill in the art. In a specific embodiment, the pseudo-wire may be established through one or more of the carrier networks.

In an embodiment, the central office is any network that may produce and/or receive data packets. The central office is generally comprised of a plurality of servers and backbone networks. The central office may be a PSN, a public switched telephone network (PSTN), a public land mobile network (PLMN), a frame relay (FR) network, an Asynchronous Transfer Mode (ATM) network, an IP network, or a MPLS network. In addition, the central office may include a signal/service switching point (SSP). Because the central office may produce and/or receive data packets, the central office may be either a source or a destination as those terms are used herein.

In an embodiment, the pseudo-wires transport data packets across the carrier networks. More specifically, the pseudo-wires may be network connections that emulate the operation of a native service. In reality, the pseudo-wires may comprise one or more wires, connections, or other network connectivity systems that may be used by many different PW-CEs. However, the pseudo-wires emulate point-to-point links such that the clients and central office perceive the pseudo-wires as unshared links, wires, or circuits through the carrier networks. Any number of pseudo-wires may be available through each of the plural carrier networks. Thus, the example of a single pseudo-wire for each carrier network shown in FIG. 1 is provided for exemplary purposes and should be viewed as illustrative rather than limiting.

In an embodiment, the pseudo-wires emulate a native service such that the pseudo-wires may potentially transfer any type of network traffic over the carrier network. The native services described herein may include non-IP services, such as ATM, FR, Ethernet, low-rate time-division multiplexing (TDM), or synchronous optical network/synchronous digital hierarchy (SONET/SDH). The carrier network may include one or more IP services, such as MPLS, IP, or Layer 2 Tunneling Protocol (L2TP). Thus, pseudo-wires allow data packaged by non-IP services to be transported through IP service networks as though the data was transported along a single, unshared link, wire, or circuit using the non-IP services.

Although the pseudo-wires may transport any type of data packets, the pseudo-wires described herein are particularly suitable for transporting order sensitive data packets. As used herein, the phrase “order sensitive data packets” refers to data packets that arrive at the destination in the same order that the data packets were sent by the source. The pseudo-wire emulation described herein is advantageous because it allows the data packets to be transported along the same route through the carrier network. Because the data packets all follow the same route through the carrier network, the data packets arrive at the destination in the same order that they were originated by the source. Thus, pseudo-wires are suitable for transporting order sensitive data packets.

In an embodiment, the PW-CEs create and/or maintain the pseudo-wire connection through the carrier networks. Each PW-CE is connected to a plurality of carrier networks such that the PW-CE can establish the pseudo-wire connections across the carrier networks. More specifically, the PW-CEs may be configured to place data on the plural pseudo-wires prior to handing the data over to the carrier network. In addition, the PW-CEs monitor the status of the pseudo-wire connections and re-route the data packets to other pseudo-wires if one of the pseudo-wires fails.

Any PW-CE may establish a pseudo-wire with any other PW-CE. When a source PW-CE wants to establish a pseudo-wire connection with a destination PW-CE, the source PW-CE sends a message to the destination PW-CE indicating the desire to establish the pseudo-wire. If the destination PW-CE agrees to establish the pseudo-wire, the destination PW-CE sends a message to the source PW-CE, the various links in the pseudo-wire path are identified, and then the pseudo-wire is established. When the source PW-CE receives non-IP data to transmit along the pseudo-wire, the source PW-CE encapsulates the non-IP data in IP packets and transports the data over the pseudo-wire to the destination PW-CE. The destination PW-CE then unwraps the data and processes the data as desired.

In an embodiment, multi-homing may be used to increase the overall reliability of the network connections. Multi-homing is the process by which the PW-CEs monitor the pseudo-wires and reroute data packets along different pseudo-wires if there is a problem with any particular pseudo-wire. For example, the PW-CE 14 may announce an address space to its upstream links, including PW-CE 20. The address space announcement informs all of the affected links that a pseudo-wire has been created between the two PW-CEs. When one of the pseudo-wire links fails, PW-CEs 14 and 20 are alerted to the failed link and discontinue transporting traffic over the failed link. The PW-CEs 14 and 20 may be alerted to the affected link or node, for example, using a routing protocol error message that is propagated upstream and downstream of the affected link or node. Thus, multi-homing allows PW-CEs to monitor the pseudo-wires for faults, failures, partial failures, or other network conditions that affect the performance and/or reliability of the pseudo-wire.

In an embodiment, the PW-CEs are part of the client or central office, rather than part of the carrier network. When the PW-CE is configured at the client or central office, it is said to be part of the customer edge, rather than part of the provider edge. If the PW-CE is located on the client side, such as PW-CE 14, the PW-CE may be part of a wire-line access node, such as a DSLAM, or part of a wireless access node, such as a RNC. If the PW-CE is located on the central office side, such as PW-CE 20, the PW-CE may be part of the SSP. Such a configuration is also advantageous because it allows the PW-CE to avoid sending data to a carrier network with a faulty line, node, or pseudo-wire.

Another advantage of the PW-CE is that it is able to route order sensitive data packets over the carrier networks without using a transport protocol, such as TCP. Specifically, when the PW-CE uses a pseudo-wire to transport data packets across the carrier networks, the order of the data packets is maintained without having to use a transport protocol. In this way, PW-CE can route order sensitive data over one or more carrier networks through multiple pseudo-wires depending upon network conditions. Thus, the functionality of IP data transfer can be combined with the redundancy of multiple carriers without the need to add a transport protocol.

In an embodiment, the PW-CEs contain pseudo-wire routing tables. The pseudo-wire routing tables identify all of the carrier networks that are connected to the PW-CEs. The pseudo-wire routing tables also identify one or more paths through the carrier networks that may be used to establish the pseudo-wires. Thus, when a link or node in a carrier network fails, the PW-CE can use the pseudo-wire routing table to determine which pseudo-wires pass through the affected node or link, and route the data packets to one of the unaffected pseudo-wires.

In an embodiment, the PW-CEs may participate in multiple concurrent data sessions. As used herein, the term “data session” refers to the transmission of a plurality of data packets across a pseudo-wire. When two or more data sessions occur concurrently, each data session is unaware of the presence of any other data session occurring on the pseudo-wire or the PW-CEs. In an embodiment, the two concurrent data sessions may contain order sensitive data. For example, a data session may be a VOIP call between the client 12 and the central office 22 using pseudo-wire 24. Concurrently, a second, distinct VOIP session may also be passing through one or both of the PW-CEs 14 or 20 and perhaps pseudo-wire 24. In this example, the two VOIP sessions are independent of each other, and while both contain order sensitive data, the data in the two VOIP sessions is not considered order specific with respect to each other. In an alternative embodiment, an order sensitive data session may occur concurrently with an order insensitive data session. For example, the VOIP call described above can pass through the same PW-CE or pseudo-wire as data packets that are not order sensitive, such as data regarding the status of the network, the available routing tables, a single ping, or diagnostic data. Persons of ordinary skill in the art will appreciate that any number of concurrent data sessions are included within the scope of the network configuration described herein.

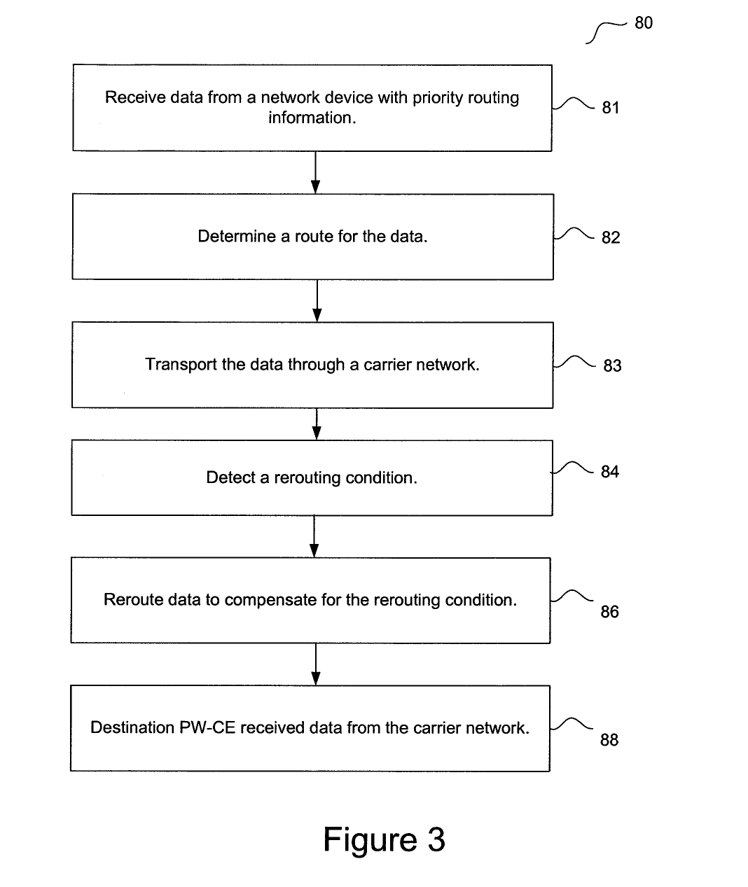

FIG. 3 is a flowchart of one embodiment of a method 40 for transporting data over a network. If desired, the method 40 may be used to transport data over the networks illustrated in FIG. 1. The method 40 begins when a source PW-CE receives data from a client (Block 41). In an embodiment, the data received by the source PW-CE may be order sensitive data. The route for the data is then determined (Block 42). The data is then transported through the carrier network along the route (Block 44). Finally, the destination PW-CE receives the data from the carrier network (Block 46). The various steps of the method 40 are described in detail below.

After the source PW-CE receives the data from the client, a route for the data to take through the carrier network has to be determined (Block 42). If there is only one pseudo-wire connecting the source PW-CE to the destination PW-CE, then that pseudo-wire is the route that the data will take through the network. However, there may be several different pseudo-wires connecting the source PW-CE to the destination PW-CE. When multiple pseudo-wires exist, one specific pseudo-wire from the plural pseudo-wires must be selected before the data can be transported through the carrier network.

In one embodiment, the data is routed through the carrier network using an automatic load-balancing scheme that separates the data streams over the plural pseudo-wires. For example, if two pseudo-wires exist, a first data may be transported through the first pseudo-wire and a second data may be transported through the second pseudo-wire. The two data streams and any subsequent data streams are distributed to the two pseudo-wires such that substantially the same amount of traffic passes through the two pseudo-wires. This allows the source PW-CE to distribute different data streams over different carrier networks, while ensuring that each individual data only passes through a single carrier network and that all available pseudo-wires are equally utilized.

In another embodiment, the data's properties may be used to determine the route for the data. Each data contains several properties that may distinguish the data from other data streams. The properties include: the specific source or client, the specific destination, the size of the data, the class of service (CoS), the quality of service (QoS), the cost of service, the type of data, the data's native protocol, the data's originating Medium Access Control (MAC) address, whether the data is order sensitive data, as well as other properties known to persons of ordinary skill in the art. These properties can be used to classify and/or prioritize the incoming data streams. Classification refers to merely identifying the properties of the data, whereas prioritization refers to routing a data before a previously received data based on the properties of the data. If a data is prioritized with respect to other data streams, then the data is treated as though it were received prior to the data streams over which it is prioritized.

Once the data has been classified and/or prioritized, a plurality of routing policies may be used to determine the route for the data. Policies are a list of rules that govern how data streams are routed through the carrier networks. Policies are generally defined in an “If A, then B” format. For example, a simple policy would be “If the data stream is associated with a standard CoS, then only use the primary route. These policies may be contained in a database in or near the PW-CE. In one embodiment, the policies are embodied in a routing table. Table 1 is an example of a routing table based on the CoS of the data:

TABLE 1

| Route | Premium CoS | Standard CoS |
|---|---|---|
| Primary | Route 1 | Route 1 |
| Secondary | Route 2 | None |

Table 1 contains a routing policy based on CoS when two different routes are available to transport data across the carrier network. Specifically, the data is classified as either a premium CoS or a standard CoS. In an embodiment, the premium CoS may include more reliability or better QoS than the standard CoS. As shown in Table 1, the data with the premium CoS may use route 1 and/or route 2, while the data with the standard CoS may only use route 1. In a specific embodiment, the data with the premium CoS may use the primary route until some routing criteria is met, at which point the data with the premium CoS is routed over the secondary route. Examples of routing criteria include: packet transmission time thresholds, faults, network congestion, route availability, and other criteria known to persons of ordinary skill in the art. While routing criteria includes rerouting conditions as the concept is discussed below, rerouting conditions also include several factors that are not rerouting conditions, but that affect the QoS of the data. When the routing criteria is met, the data with the premium CoS is routed along the secondary route, while the data with the standard CoS continues to use the primary route.

PW-CE then transports the data to the destination PW-CE through carrier network (Block 44). In the process of sending data, source PW-CE establishes a pseudo-wire connection with destination PW-CE, if such is not already established. Since the source PW-CE transports all of the data through a particular pseudo-wire, the destination PW-CE receives the data from the carrier network (Block 46) in the same order that the data was originated by the source PW-CE.

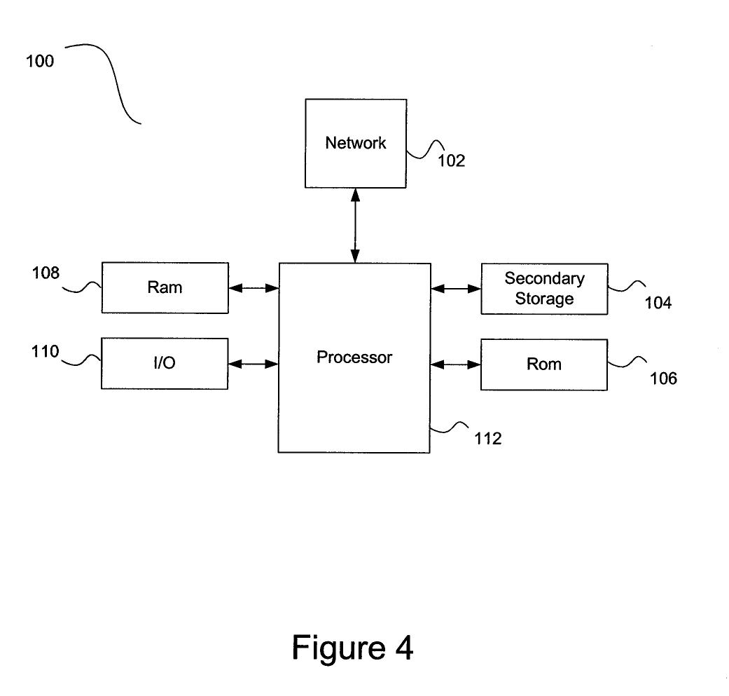

It is possible that a fault or other pseudo-wire problem may be encountered prior to or during transport of the data across the pseudo-wire. In such a case, a routing method that allows the data to be reroute may be implemented. FIG. 4 is a flowchart of an embodiment of a routing method 80 that allows the data to be reroute. In method 80, block 81 is substantially similar to block 41 in FIG. 3, block 82 is substantially similar to block 42 in FIG. 3, block 83 is substantially similar to block 44 in FIG. 3, and block 88 is substantially similar to block 46 in FIG. 3. However, method 80 differs from method 40 in FIG. 3 in that method 80 detects a rerouting condition (Block 84) and reroute data to compensate for the rerouting condition (Block 86). These blocks are discussed in detail below.

In an embodiment, method 80 detects a rerouting condition (Block 84). A rerouting condition may be anything that affects the flow of data through the carrier network. Examples of rerouting conditions include: network faults, the addition of new network routes, network congestion, or other network condition. In a specific embodiment, the rerouting condition may also be the result of a partial failure in the carrier network. A partial failure may be any type of failure that interrupts the flow of data, including the partial loss of available network bandwidth, temporary network congestion, and reduced bandwidth. The multi-homing scheme described above is one method by which a rerouting condition may be detected. Persons of ordinary skill in the art are aware of other methods for detecting rerouting conditions.

In an embodiment, method 80 reroute the data to compensate for the rerouting condition (Block 86). For example, if there is a network fault, the source PW-CE may reroute data from one network carrier to another, creating a second pseudo-wire for the alternative data path and stopping traffic over the faulty network. Alternatively, the source PW-CE may use the policies described herein to reroute the data through the carrier network. When using the policies described herein, the determination whether data is reroute and the determination which path to reroute the data to may be dictated by one or more properties of the data, including the data's CoS. The use of policies to reroute data has a number of advantages, including the ability to prioritize the movement of data by the data's CoS, balancing data with different CoS among different networks, as well as providing enhanced reliability to data with certain CoS. Moreover, the use of policies to reroute data could also be used in conjunction with bandwidth requirements to optimize network utilization, control the flow and movement of data, and minimize cost by balancing the amount of traffic pushed through a particular network against the relative costs associated with using that network.

In one embodiment, the rerouting policies are embodied in a rerouting table. Table 2 is an example of a rerouting table based on the CoS of the data:

TABLE 2

| Policy | Policy 1 | Policy 2 |
|---|---|---|
| Route | Premium CoS | Premium CoS |
| Primary | 50% of data over Route 1 | 100% of data over Route 1 |
| Secondary | 50% of data over Route 2 | 0% of data over Route 2 |

Table 2 contains routing policies for the premium CoS data when two different routes are available to transport data across the carrier network. As shown in Table 2, the data with the premium CoS may be balanced over two routes according to the proportions described in the policy. Under Policy 1, 50 percent of the premium CoS data may be routed over Route 1, while the remaining CoS data may be routed over Route 2. If a rerouting condition is detected in either Route 1 or Route 2, then the data stream may be routed over the unaffected route. Under policy 2, 100% of the premium CoS data may be routed over Route 1 until a rerouting condition is detected, at which point the data stream gets routed to Route 2. It is contemplated that any combination of proportions may be used in routing policies. For example, if A percent of the premium CoS data is routed over Route 1, then (100-A) percent may be routed over Route 2, where the range of “A” is between 0 and 100.

The routing policies described herein may be implemented at any one of a plurality of policy decision points (PDPs). For example, the PDP may be the client, the source PW-CE, any point along the pseudo-wire, the destination PDP, or the central office. Persons of ordinary skill in the art are aware of other places where the PDP may be located.

The network described above may be implemented on any general-purpose computer with sufficient processing power, memory resources, and network throughput capability to handle the necessary workload placed upon it. FIG. 5 illustrates a typical, general-purpose computer system suitable for implementing one or more embodiments of a PW-CE disclosed herein. The computer system 100 includes a processor 112 (which may be referred to as a central processor unit or CPU) that is in communication with memory devices including secondary storage 104, read only memory (ROM) 106, random access memory (RAM) 108, input/output (I/O) 110 devices, and network connectivity devices 102. The processor may be implemented as one or more CPU chips.

The secondary storage 104 is typically comprised of one or more disk drives or tape drives and is used for non-volatile storage of data and as an over-flow data storage device if RAM 108 is not large enough to hold all working data. Secondary storage 104 may be used to store programs that are loaded into RAM 108 when such programs are selected for execution. The ROM 106 is used to store instructions and perhaps data that are read during program execution. ROM 106 is a non-volatile memory device that typically has a small memory capacity relative to the larger memory capacity of secondary storage. The RAM 108 is used to store volatile data and perhaps to store instructions. Access to both ROM 106 and RAM 108 is typically faster than to secondary storage 104.

I/O 110 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 102 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 102 devices may enable the processor 112 to communicate with an Internet or one or more intranets. With such a network connection, it is contemplated that the processor 112 might receive information from the network, or might output information to the network in the course of performing the above-described method steps. Such information, which is often represented as a sequence of instructions to be executed using processor 112, may be received from and outputted to the network, for example, in the form of a computer data signal embodied in a carrier wave.

Such information, which may include data or instructions to be executed using processor 112 for example, may be received from and outputted to the network, for example, in the form of a computer data baseband signal or signal embodied in a carrier wave. The baseband signal or signal embodied in the carrier wave generated by the network connectivity 102 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 112 executes instructions, codes, computer programs, scripts which it accesses from hard disk, floppy disk, optical disk (these various disk based systems may all be considered secondary storage 104), ROM 106, RAM 108, or the network connectivity devices 102.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A telecommunications network component comprising:
a processor configured to implement a method comprising:
receiving a data stream;
establishing a virtual connection with a destination through one of a plurality of networks; and
configuring the data packets for transportation to the destination over the virtual connection;
wherein the data packets follow the virtual connection through the carrier network so long as a rerouting condition is not detected.

2. The network component of claim 1, wherein the virtual connection is a pseudo-wire.

3. The network component of claim 1, wherein the data stream contains order specific data.

4. The network of claim 1, wherein the method further comprises multi-homing to detect the rerouting condition.

5. The network component of claim 1, wherein the virtual connection extends from a first consumer edge to a second consumer edge.

6. The network component of claim 1, wherein the virtual connection does not contain a transfer control protocol.

7. The network component of claim 1, wherein the method further comprises:
establishing a plurality of virtual connections through the networks; and
using a routing table to determine which virtual connection on which to transport the data stream.

8. The network component of claim 1, wherein the method further comprises using a routing table to prioritize a plurality of the data streams based upon the characteristics of each data stream.

9. The network component of claim 8, wherein the method further comprises balancing the data streams over a plurality of the virtual connections based on the load of each virtual connection.

10. The network component of claim 1, wherein the method further comprises rerouting the data stream when a rerouting condition is detected.

11. The network component of claim 10, wherein the rerouting condition is a partial network failure.

12. A method of routing order sensitive data, comprising:
providing a connection to a plurality of carrier networks;
establishing a plurality of pseudo-wires through the carrier networks;
transmitting an order specific data over one of the pseudo-wires; and
multi-homing to detect a rerouting condition on one of the pseudo-wires.

13. The method of claim 12, further comprising: load balancing a plurality of the data streams over the pseudo-wires.

14. The method of claim 12, further comprising:
detecting a rerouting condition; and
rerouting the data stream over the pseudo-wires based on the rerouting condition.

15. The method of claim 12, further comprising using a plurality of policies to reroute the data stream over the pseudo-wires.

16. A system for transporting and receiving order specific data, comprising:
a pseudo-wire device operable for communication with a plurality of carrier networks, the pseudo-wire device configured to establish a plurality of pseudo-wires through the carrier networks and route a plurality of data streams through the pseudo-wires; and
a policy-based routing table accessible by the pseudo-wire device, wherein the pseudo-wire device uses the routing table to determine the pseudo-wires on which to route the data streams.

17. The system of claim 16 wherein the pseudo-wire device is part of the customer edge.

18. The system of claim 16, wherein the pseudo-wire device routes traffic based upon a policy selected from the group of: quality of service, load balancing, quality of service, and class of service.

19. The system of claim 16 wherein the pseudo-wire device reroute data across the pseudo-wires when a rerouting condition is detected.

20. The system of claim 17, wherein the data stream is a non-Internet protocol (IP) based data stream and the carrier networks are packet switched networks.
